(19) United States
(12) Patent Application Publication
(10) Pub. No.: US 2009/0018266 A1
(43) Pub. Date: Jan. 15, 2009

(54) Preparation of hydrophilic nanoparticles by copolymerization of mono and divinyl monomers in micellar solution

(76) Inventors: Janos Borbely, Debrecen (HU); John F. Hartmann, Princeton, NJ (US)

Correspondence Address: Thomas A. O'Rourke;Bodner & O'Rourke, 425 Broadhollow Road, Melville, NY, 11747, US

(21) Appl. No.: 11/598,548

(22) Filed: Nov. 13, 2006

Related U.S. Application Data
(60) Provisional application No. 60/735,930, filed on Nov. 10, 2005.

(51) Int. Cl. C08F 30/02; C08F 2/24

(52) U.S. Cl. 524/745; 526/234; 526/278; 525/326.6

(57) ABSTRACT

The present invention relates to the preparation of hydrophilic nanoparticles and in particular hydrophilic nanoparticles that are biocompatible. Free radical monovinyl-divinyl monomer copolymerization/cross-linking reactions of water-soluble, monovinyl N-vinyl-2-pyrrolidone (NVP) with a bi-unsaturated divinyl, comonomer (poly{ethylene glycol}dimethacrylate) (PEGDMA), has been found to yield hydrophilic nanoparticles (NPs). These nanoparticles are built from three-dimensional nanopolymer networks. In the polymers' synthesis the composition of the monomers, and the total monomer concentration were varied. The characteristics of copolymers were determined by nuclear magnetic resonance spectroscopy (NMR), Fourier transform infrared (FTIR) and elemental analysis. Particle size and morphology of nanoparticles were confirmed by dynamic light scattering (DLS), transmission electron microscope (TEM) and scanning electron microscope (SEM) methods. In the present invention hydrophilic polymers can be used in micellar polymerization to create hydrophilic nanoparticles.

This application claims priority on U.S. Application Ser. No. 60/735,930 filed Nov. 10, 2005, the disclosures of which are incorporated herein by reference

### FIELD OF THE INVENTION

The present invention is directed to unique hydrophilic nanoparticles that are useful in a variety of applications. These applications include but are not limited to drug delivery, coating applications and other uses.

### BACKGROUND OF THE INVENTION

Hydrophilic nanoparticles are known in the art. The term hydrophilic in relation to nanoparticles refers to the property of a molecule or functional group of a molecule to penetrate the aqueous phase or to remain in the aqueous phase. Nanoparticles are a microscopic particles whose size is measured in nanometres (nm). A nanoparticle is typically defined as a particle with at least one dimension <200nm. Nanoparticles have also been defined as solid colloidal particles ranging in size from about 10 nm to 1000 nm. See U.S. Pat. No. 5,874,111

Nanoparticles have been the subject of great scientific interest as they are effectively a bridge between bulk materials and atomic or molecular structures. A bulk material usually has constant physical properties regardless of its size, but at the nano-scale this is often not the case. Size-dependent properties are observed such as quantum confinement in semiconductor particles, surface plasmon resonance in some metal particles and superparamagnetism in magnetic materials. Semi-solid and soft nanoparticles have been manufactured. A prototype nanoparticle of semi-solid nature is the liposome. A liposome is a spherical vesicle with a membrane composed of a phospholipid and cholesterol bilayer. Liposomes can be composed of naturally-derived phospholipids with mixed lipid chains (like egg phosphatidylethanolamine), or of pure surfactant components like DOPE (dioleolylphosphatidylethanolamine). Liposomes, by definition, contain a core of aqueous solution. Lipid spheres that contain no aqueous material are called micelles. Liposomes have been used for drug delivery due to their unique properties.

The properties of nanoparticles are partly due to the aspects of the surface of the material dominating the properties in lieu of the bulk properties. For example, the percentage of atoms at the surface of a material becomes significant as the size of that material approaches the nanoscale. For bulk materials larger than one micrometre the percentage of atoms at the surface is minuscule relative to the total number of atoms of the material.

Suspensions of nanoparticles are possible because the interaction of the particle surface with the solvent is strong enough to overcome differences in density, which usually result in a material either sinking or floating in a liquid. Nanoparticles often have unexpected visible properties because they are small enough to scatter visible light rather than absorb it.

Hydrophillic, refers to a physical property of a molecule that can transiently bond with water (H₂O) through hydrogen bonding. This is thermodynamically favorable, and makes these molecules soluble not only in water, but also in other polar solvents. A hydrophilic molecule or portion of a molecule is one that is typically charge-polarized and capable of hydrogen bonding, enabling it to dissolve more readily in water than in oil or other hydrophobic solvents. Nanotechnology is one of the most dynamically developing scientific areas. It has opened new perspectives in pharmacy, dentistry, electronics, etc. Nanotechnology also has applicability in the purification of water and the reduction of air pollution. Water soluble biocompatible polymers with a size range of 50-150 nm are widely used for a variety of applications, including biomedical applications. The biomedical applications can include cell adhesives and drug delivery systems, etc.

Various types of polymerization techniques are available for preparing hydrophobically modified polymers. For example, Micellar polymerization techniques can be used for preparation of hydrophobically modified water-soluble polymers. See Juntao M a, Ping Cui, Lin Zhao, Ronghua Huang.: Europ. Polym. J. 38, 1627-1633 (2002); I. V. Blagodatskikh, O. V. Vasil'eva, E. M. Ivanova, S. V. Bykov, N. A. Churochkina, T. A. Pryakhina, V. A. Smirnov, O. E. Philippova, A. R. Khokhlov: Polymer 45, 5897-5904 (2004); W. Xue, I. W. Hamley, V. Castelletto, P. D. Olmsted: Europ. Polym. J. 40, 47-56 (2004), the disclosures of which are incorporated herein by reference. These kinds of polymers typically contain a small proportion of hydrophobic groups (3 mol % or less), which are capable of nonspecific hydrophobic association (intramolecular or intermolecular) in aqueous solution.

Polymerization of monomers with one and two double bonds presents a major difficulty which originates from the insolubility of the divinyl monomer in water. Vinyl monomers with two double bonds have low solubility in water that reduces the range of concentration ratio. Two methods have been disclosed to overcome this problem [F. Candau, J. Selb: Adv. Colloid Interface Sci. 79, 149-172 (1999)]:

1) Polymerization in an organic solvent or a water-based solvent mixture in which both polymers are soluble. The copolymers are not soluble in a reaction medium, it is called precipitation polymerization. If the copolymer remained in solution it is termed as homogenous polymerization.

2) Micellar polymerization where an aqueous surfactant solution ensures the solubilization of the hydrophobic monomer within the micelles. See F. Candau, J. Selb: Adv. Colloid Interface Sci. 79, 149-172 (1999).

Free radical polymerization in homogenous solutions gives wide size distribution polymers or gels [E. Szuromi, M. Berka, and J. Borbely, Macromolecules 33, 3993 (2000)]. Cross-linked Polymers with narrow distribution and lower size can be prepared using smaller monomer concentration. It should be emphasized that such a micellar process differs strongly from other polymerizations carried out in the presence of a surfactant, i.e. emulsion or microemulsion processes. In this technique use of a surfactant is necessary to solubilize the monomers into micelles dispersed in water. Sodium dodecyl sulphate (SDS) makes insoluble monomers soluble in water, thus there is broader application.

To provide the synthesis of copolymers with the desired properties, it is necessary to ascertain the correlation between synthesis conditions and molecular characteristics of the prepared polymer.

### SUMMARY OF THE INVENTION

The hydrophilic nanoparticles of the present invention can be prepared by modifying a normally linear polymer such as PGA or polyacrylic acid (PAA), but it also can be synthesized from monomers including but not limited to N-vinyl-2 pyrrolidone, vinyl monomers, acrylic acid monomers(NVP, VI, AA). Cross-linked polymers are better than comb-like/linear polymers for this purpose, because of their porosity. Also, the polymer structure isn't altered much, and the viscosity of the polymers doesn't change greatly with the concentration.

Cross-linked polymers can also be formed from bifunctional monomers such as BMOEP, PEGDMA but using these monomers can cause macroscopic gels in the reaction products. In the present invention the preferred method of synthesis of NPs was micellar radical polymerization. In this process water-soluble monomers (AA, VI, NVP) are dissolved in water, while less water-soluble hydrophilic comonomers or insoluble hydrophobic comonomer is solubilized in micelles of tenside molecule. The growing radicals were separated by tensid molecules in a microheterogeneous system. In micellar polymerization water-soluble initiators were used which found to be the preferred choice whether the monomers had high or low water solubility.

The present invention also relates to cross-linked hydrophilic nanoparticles that can be prepared by copolymerization of acrylic acid (AA) with bis-[2-(methacryloyloxy)-ethyl]-phosphate (BMOEP) as crosslinking agent. In one embodiment, the polymerization reaction is a free radical polymerization initiated with potassium persulphate. In a first embodiment, the polymerization reaction occurs in a homogenous solution using a dioxane-water mixture as a solvent. In a second embodiment, the polymerization reaction occurs in a sodium dodecyl sulphate (SDS) solution.

The present invention is further directed to methods of making synthesized nanoparticles with designed size, composition, porosity and functionality. If the reaction conditions of copolymerization (like monomers and their ratio, concentrations, temperature) change, the properties of the synthesized copolymers (particle size, porosity, hydrophilicity) will alter.

Polymerization of water soluble monomers in an aqueous solution gives wide size distribution polymers. Adding small amounts of divinyl monomer the reaction can be so quick that gelation occurs. Polymers with narrow distribution and low size cannot be prepared in that way. Furthermore, vinyl monomers with two double bonds have low solubility in water composition.

In inverse emulsion, because monomers with two double bonds migrates into the organic phase producing gelation. To avoid the problems encountered in emulsion polymerization, the present invention uses monomers soluble in toluene. A monomer with double bonds is more soluble in toluene than water. In the organic solvent gelation occurs again, but if we decrease the monomers concentration of the reaction mixture by driving the organic phase into emulsion. Gelation can be prevented. Furthermore, the size distribution also can be made narrower.

In another embodiment of the invention Polyacrylic Acid (PAA) can be easily modified in an aqueous solution by amidation with a diamino compound (EDBEA). Crosslinked derivatives (PAANPs) with different crosslinking ratios were obtained starting from PAA with Mw in the range of 100 and 750 kDa. Particle size of dried PAANPs was measured by TEM and was in a range of 80-95 nm. Hydrated volume of swelled PAANPs depends on the crosslinked ratio. The small particle size of the PAANP indicates that they should be good drug delivery vehicles.

The hydrophilic nanoparticles of the present invention have applicability In biomedical applications as drug carriers or imaging agents, delivery systems for drugs and vaccines. Other applications include coating and sealing materials, dental products such as dental and medical restoration; i.e., dental restoratives and bone repair, soil release modification of textile surfaces, leather, hard smooth surfaces and hard porous surfaces.

### BRIEF DESCRIPTION OF THE DRAWINGS

FIG. 1 is a schematic mechanism of copolymerization and formation of cross-linking.

FIG. 2 which shows the Conversion-PEGDMA fraction curves for NVP-PEGDMA copolymers.

FIG. 3 shows the 500 MHz ¹H-NMR spectrum of a 20% cross-linked NVP-PEGDMA copolymer. Bulk of total monomer: 2.0 g. ¹H-NMR chemical shifts of NPs were assigned according the ¹H 500 MHz NMR spectrum in D₂O.

FIG. 4 shows the 500 MHz 2D ¹H-¹³C HSQC NMR effect spectrum of a 20% cross-linked NVP-PEGDMA copolymer in D₂O at 335K. Bulk of total monomer: 2.0 g.

FIG. 5 shows the FT-IR spectrum of NVP-PEGDMA nanoparticles. Significant bands are v=˜1680 cm⁻¹ (amide linkage), v=˜1720 cm⁻¹ (carbonyl group of ester linkage). Cross-linking: 0.2 PEGDMA fraction in feed.

FIG. 6a is a TEM micrograph of 20% cross-linked NVP-PEGDMA copolymer. Bulk of total monomer: 2.0 g. The bar in the Figure is 50 nm.

FIG. 6b is a TEM micrograph of 20% cross-linked NVP-PEGDMA copolymer. Bulk of total monomer: 2.0 g. The bar in the Figure is 100 nm.

FIG. 7 is a SEM photograph of NVP-PEGDMA copolymer nanospheres. Feed solution contains 20% cross-linking and 80% NVP. Bulk of total monomer: 2.0 g.

FIG. 8 shows the evolution of diameter and polydispersity index (PDI) with PEGDMA ratio (by light scattering analyser). Bulk of total monomer: 2.0 g.

FIG. 9 shows Intensity—size distribution obtained by DLS at Q 90°, 1=532 nm, calculated by NNLS. Bulk of total monomer: 2.0 g. Monomer ratio: A-8/2, B-7/3, C-5/5, D-3/7, E-2/8 NVP-PEGDMA.

FIG. 10 is a ¹H NMR spectrum of AA-BMOEP (2:8). d=0.5-1.5 ppm (CH₂), d=1.6-2.6 ppm (CH), d=2.8 ppm (CH—O—CO), d=3.7 ppm (3-CH—O—PO₃), d=3.9-4.7 ppm (CH—COOH).

FIG. 11 shows GPC peaks of AA-BMOEP (A:B) crosslinked hydrophilic copolymer nanoparticles with monomer feed of A:B=2:8, 5:5 and 8:2 (M) obtained by micellar polymerization process, (D) obtained by homogeneous mixed solvent (water-dioxane) medium.

FIG. 12 is an IR spectrum of AA-BMOEP (2:8). The IR analysis proves the formation of amide bond between the amine group of crosslinker and the carboxylic group of PAA. Significant bands are: n=3470 n=2353 n=1642 (CO).

FIG. 13 is a TEM micrograph of a water soluble copolymer (bar=100 nm).

FIG. 14 is a ¹H-NMR spectrum of 20% crosslinked NVP-co-PEGDMA copolymer.

FIG. 15 is a FT-IR spectrum of NVP-PEGDMA showing the present of nitrogen.

FIG. 16. TEM micrograph of NVP-PEGDMA copolymer 50% crosslinked

FIG. 17 is the crosslinking reaction of PAA.

FIG. 18 is the ¹H NMR of 50% crosslinked PAANP (M_{w} of starting PAA was 100 kDa): delta=1.5-2.0 ppm (CH₂-AA monomer unit), delta=2.1-2.5 ppm (CH-AA monomer unit), delta=3.2 ppm (1-CH₂), delta=3.7 pm (3-CH₂), delta=3.8 ppm (2-CH₂).

FIG. 19 is ¹³C NMR of 75% crosslinked PAANP (PAA M_{w}=450 kDa): delta-36.7 ppm (CH₂-AA monomer unit), delta-43.5 ppm (CH-AA monomer unit), delta-39.3 ppm (1-CH₂), delta=66.6 ppm (2-CH₂), delta=69.8 ppm (3-CH₂), delta=177.4 ppm (CONH), delta=181.3 ppm (COOH).

FIG. 20 is IR spectra of 15% crosslinked PAANP (PAA M_{w}+100 kDa). The IR analysis proves the formation of amide bonds between the amine group of crosslinker and the carboxylic group of PAA. Significant bands are: v=1709 (COOH), v=1628 (CO), v=1552 (Amide 1).

FIG. 21 is dependence of the diameter on crosslinking ratio. M_{w} of starting PAA was 450 and 750 kDa, and the crosslinking ratio was 25%, 50% and 75%, respectively.

### DETAILED DESCRIPTION OF THE INVENTION

The hydrophilic nanoparticles of the present invention can be prepared by modifying a normally linear polymer such as PGA or polyacrylic acid (PAA), but it also can be synthesized from monomers including but not limited to (NVP, VI, AA). Cross-linked polymers are preferred because of their porosity. Also, the polymer structure isn't altered much, and the viscosity of the polymers doesn't change greatly with the concentration.

Cross-linked polymers can also be formed from bifunctional monomers such as BMOEP, PEGDMA and the like. Using these monomers, however, can cause macroscopic gels in the reaction products. The preferred method of synthesis of nanoparticles (NPs) was micellar radical polymerization. In this process water-soluble monomers (AA, VI, NVP) are dissolved in water, while less water-soluble hydrophilic comonomers or insoluble hydrophobic comonomer is solubilized in micelles of tenside molecule. The growing radicals were separated by tensid molecules in a microheterogeneous system. In micellar polymerization water-soluble initiators were used which found to be the preferred choice whether the monomers had high or low water solubility.

The present invention also relates to cross-linked hydrophilic nanoparticles that can be prepared by copolymerization of acrylic acid (AA) with bis-[2-(methacryloyloxy)-ethyl]-phosphate (BMOEP) as crosslinking agent. In one embodiment, the polymerization reaction is a free radical polymerization initiated with potassium persulphate. In a first embodiment, the polymerization reaction occurs in a homogenous solution using a dioxane-water mixture as a solvent. In a second embodiment, the polymerization reaction occurs in a sodium dodecyl sulphate (SDS) solution.

The present invention is further directed to methods of making synthesized nanoparticles with designed size, composition, porosity and functionality. If the reaction conditions of copolymerization (like monomers and their ratio, concentrations, temperature) change, the properties of the synthesized copolymers particle size, porosity, hydrophilicity) will alter.

Polymerization of water soluble monomers in an aqueous solution gives wide size distribution polymers. Adding small amounts of divinyl monomer the reaction can be so quick that gelation occurs. Polymers with narrow distribution and low size cannot be prepared in that way. Furthermore, vinyl monomers with two double bonds have low solubility in water composition.

In inverse emulsion, because monomers with two double bonds migrates into the organic phase producing gelation. To avoid the problems encountered in emulsion polymerization, the present invention uses monomers soluble in toluene. A monomer with double bonds is more soluble in toluene than water. In the organic solvent gelation occurs again, but if we decrease the monomers concentration of the reaction mixture by driving the organic phase into emulsion. Gelation can be prevented. Furthermore, the size distribution also can be made narrower.

In another embodiment of the invention Polyacrylic Acid (PAA) can be easily modified in an aqueous solution by amidation with a diamino compound (EDBEA). Crosslinked derivatives (PAANPs) with different crosslinking ratios were obtained starting from PAA with Mw in the range of 100 and 750 kDa. Particle size of dried PAANPs was measured by TEM and was in a range of 80-95 nm. Hydrated volume of swelled PAANPs depends on the crosslinked ratio. The small particle size of the PAANP indicates that they should be good drug delivery vehicles.

The present invention me be best understood with reference to the following Examples.

### EXAMPLE 1

### Experimental

### Materials

N-vinyl-2 pyrrolidone (M₁) and poly(ethylene-glycol)-dimethacrylate (M₂) as the cross-linker were supplied by Sigma Aldrich Co., Hungary. Buthanole as a co-tensid were purchased from Spektrum 3D Co., Hungary, and deionized water were used as solvents. The initiator was potassium persulphate (Reanal Co., Budapest, Hungary, 98% purity). Sodium-lauryl sulphate was applied as an emulsifier, bought at Chemolab Co., Budapest, Hungary.

### Instruments

NMR spectroscopy. Structure of prepared colloid system was analyzed by NMR spectroscopy. ¹³C NMR spectra were obtained on a Bruker SY200, ¹H NMR and 2D maps on Bruker AM500 instruments. The samples were dissolved in deuterated water (D₂O). Small samples (50 mg) of the purified polymer were dissolved in suitable amounts (1-2 ml) of the solvent and their ¹H NMR and ¹³C NMR spectra were measured. ¹H NMR and ¹H-¹³C HSQC NMR spectra were recorded at 335 K. The chemical shifts were represented in ppm, based on the signal for sodium 3-(trimethylsilyl)-propionate-d₄ as a reference (DSS).

Infrared spectroscopy (ATR-FTIR). IR spectroscopy measurements were taken in attenuated total reflection (ATR) mode. Infrared spectra were measured by means of a Perkin Elmer Spectrum 2000 FTIR combined with an IR microscope equipped with a single-reflexion Micro-ATR accessory. The IR spectra were collected always in the wave numbers range from 4000 to 650 cm⁻¹. Instrumental resolution was set at 1 cm⁻¹.

Elemental analysis. The ratio of copolymerization in the nanospheres, the carbon and nitrogen content of copolymers were determined in an elemental analyzer (Perkin Elmer . . . )

Dynamic Light Scattering (DLS). Hydrodynamic diameter (HD), particle size distribution (PSD), and polydispersity index (PDI) of cross-linked nanoparticles were gauged by using a BI-200SM Brookhaven Research Laser Light Scattering photometer equipped with a NdYAg solid state laser at an operating wavelength of λₒ=532 nm and were calculated by a second-order fit of the instrument of the cumulant analysis of the autocorrelation function, using Non-Negative Least Square (NNLS) data elaboration. Measurements of the average nanoparticle-size were performed at 25° C. with an angle detection of 90° in optically homogeneous quartz cylinder cuvettes. The samples were prepared from the reaction compound after dialysis. The concentration of the polymer solutions was 100 μg/ml. Each sample was measured five times and average serial data were calculated.

Transmission Electron Microscopy (TEM). A JEOL2000 FX-II transmission electron microscope was used to characterized the size and morphology of the NVP-PEGDMA nanoparticles. For TEM observation, the copolymer nanoparticles samples were prepared either from the reaction compound after dialysis or from the reaction mixture after freeze-dried, when the dried polymer particles were redispersed by sonication in deionized water at concentration 500 μg/ml, and dried in the air at room temperature for 20-24 h. A drop of the mixed solution was put on a TEM specimen, which samples were placed onto 400 mesh copper grill covered by carbon coating.

Scanning Electron Microscopy (SEM). SEM measurements were performed on HITACHI S4300 CFE (Tokyo, Japan, with W emitter) at 1.5 or 10 kV instrument determine the particle size nanoparticles. Sputter-coated with gold for approximately 30 sec twice repeated to a thickness of approximately 100 nm, 18-20 mA plasm current, and the pressure was 10⁻² mPa.

Transmittance. Transparency measurement were performed with a Unicam SP 1800 Ultraviolet Spectrophotometer at an operating wavelength λ=600 nm in optically homogeneous quartz cuvettes. Dispersion of NVP-PEGDMA copolymer was prepared in deionized water at a concentration of 20 mg/ml.

MALDI-TOF MS The polymerization rate of PEGDMA were determined by MALDI-TOF measurements, which turned up to n=9. The MALDI MS measurements were performed with a Bruker BIFLEX III mass spectrometer equipped with a TOF analyzer

### Synthesis of Nanoparticles

Nanoparticles were prepared via micellar polymerization. PEGDMA is a monomer that does not dissolve well in water even if a more water soluble monomer is present resulting in low solubility. To raise its concentration in the solvent it has to give into the solution, SDS was used as SDS can solubize this monomer, in finely dispersed form.

A water soluble monomer of NVP and a less water-soluble macro monomer, PEGDMA were prepared free radical copolymerization. The reaction mixture was prepared from two phases. A continuous phase containing an anionic surfactant, sodium dodecyl sulphate (SDS), and the water soluble initiator potassium persulphate in deionized water were used. The dispersed phase consists of co-tenside (n-buthanole) and the monomers. The overall concentration of monomers was varied. The two phases were mixed, and dispersed in an ultrasonic bath for 10 minutes. A solution of potassium persulphate initiator was added and free radical polymerization was performed at 60° C. The oxygen was removed by purged nitrogen for 25 minutes at ambient temperature before the reaction was started. Nitrogen purging was continuous during the whole reaction time. The reaction was started in a water bath at 60° C. At the end of the reaction a viscous, homogeneous and clear or opalescent polymer solution were obtained. Polymerization time was two hours then the sample was cooled and dialyzed against water for a week (dialysis was performed in dialyze tubes from cellulose with a molecular weight cut-off of 12 400 Da (Sigma Aldrich, Hungary)), and were then freeze-dried in a Virtis Freeze Drier (CHRIST ALPHA 1-2) under vacuum at −52° C. for 4 days, to yield a white amorphous powder. Table 1. contains the conditions of polymerization of NVP-PEGDMA NPs in deionized water with micellar polymerization. The parameters of the reactions were varied to examine the effect of the particle size, porosity, morphology, swelling ability and the composition.

TABLE 1
Reaction condition of synthesis of NVP-PEGDMA copolymer.

| | NVP | PEGDMA | | Bulk of | | Bulk of | Reaction | |
|---|---|---|---|---|---|---|---|---|
| | fraction | fraction | Bulk of | PEGDMA | Bulk of | initiator | time | Deionized |
| SAMPLE | in feed | in feed | NVP (g) | (g) | SDS (g) | (g) | (min) | water (g) |
| VPP1 | 0.2 | 0.8 | 0.1 | 1.9 | 1.2 | 0.1 | 120 | 40 |
| VPP2 | 0.3 | 0.7 | 0.16 | 1.84 | 1.2 | 0.1 | 120 | 40 |
| VPP3 | 0.5 | 0.5 | 0.34 | 1.66 | 1.2 | 0.1 | 120 | 40 |
| VPP4 | 0.7 | 0.3 | 0.64 | 1.36 | 1.2 | 0.1 | 120 | 40 |
| VPP5 | 0.8 | 0.2 | 0.89 | 1.11 | 1.2 | 0.1 | 120 | 40 |
| P12 | — | 1.0 | — | 2.00 | 1.2 | 0.1 | 120 | 40 |
| VPP6 | 0.1 | 0.9 | 0.22 | 0.98 | 1.2 | 0.1 | 120 | 40 |
| VPP7 | 0.2 | 0.8 | 0.05 | 0.95 | 1.2 | 0.1 | 120 | 40 |
| VPP8 | 0.3 | 0.7 | 0.08 | 0.92 | 1.2 | 0.1 | 120 | 40 |
| VPP9 | 0.5 | 0.5 | 0.17 | 0.83 | 1.2 | 0.1 | 120 | 40 |
| VPP10 | 0.7 | 0.3 | 0.32 | 0.68 | 1.2 | 0.1 | 120 | 40 |
| VPP11 | 0.8 | 0.2 | 0.45 | 0.55 | 1.2 | 0.1 | 120 | 40 |
| P13 | — | 1.0 | — | 1.00 | 1.2 | 0.1 | 120 | 40 |

Co-tenside: 1.5 wt % (based on monomer) n-butanole. Initiator: potassium persulphate. Total solids: 3%. Temperature: 60° C.

### Results and Discussion.

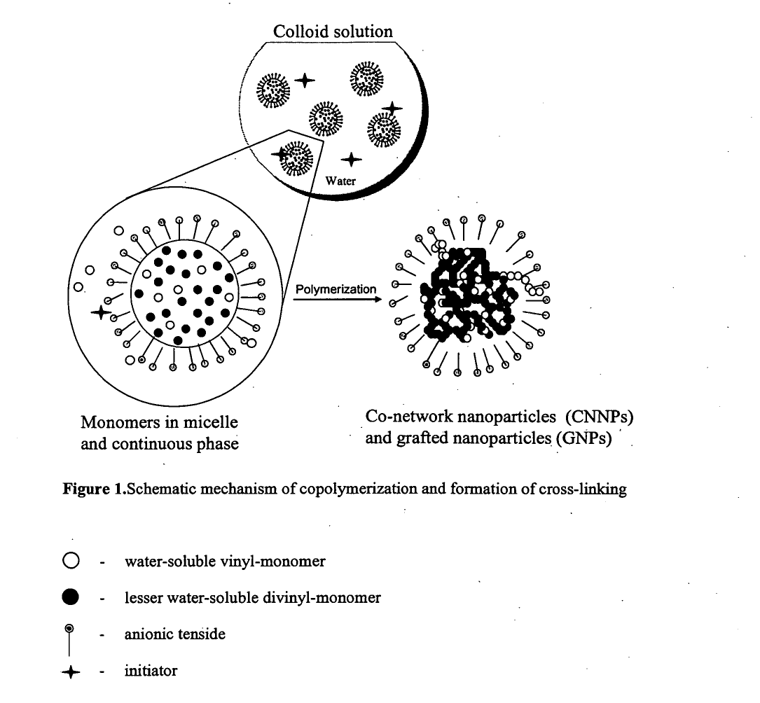

The vinyl groups of NVP were cross-linked with the divinyl monomer PEGDMA and formed in micellar polymerization, stable, inactive nanoparticles. The newly formed nanoparticles do not contain unreacted double bonds. In the case of copolymerization of vinyl/divinyl monomers as shown in FIG. 1, the double bond of the divinyl group from a PEGDMA molecule can react with the vinyl group from the NVP or with a double bond from another PEGDMA molecule in the micelles. If a second polymer radical is added to the pendant double bond, a cross-linkage will be formed. Further branching leads eventually to cross-linking particles in micelles, during the continuous phase the NVP, i.e. network formation.

Polymerization of water soluble monomers in aqueous solution results in a broad size distribution polymers. Adding a small amount of divinyl monomer which enhances especially the viscosity, to the reaction can result in rapid gelation. Polymers with narrow distribution and small size cannot be prepared in that way. Furthermore, vinyl monomers with their double bonds, have low solubility in water, thereby limiting their useful range of concentration, and this seriously limits the degree of cross-linking as well. Additionally, an inverse emulsion cannot be prepared, because monomers with two double bonds migrate into the organic phase producing gelation.

A novel particular was the eventuality of adjusting the copolymer nanostructure by changing the PEGDMA fraction in feed to 90 percentage in the micelles.

Micellar polymerization method was the increased reactivity of the PEGDMA macro monomer when solubilized in the micelles. In the present invention colloid-water soluble or dispersable particles were synthesized from biocompatible polymers and design particles of pre-determined size, composition, porosity and functionality.

### Conversion

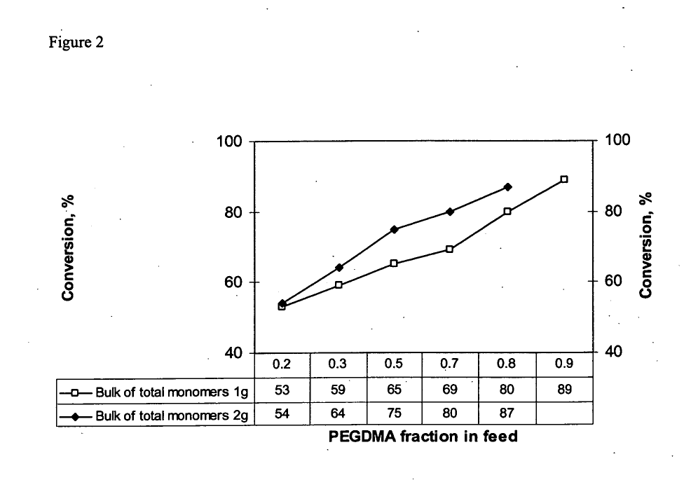

FIG. 2. shows the effect of total monomers concentration on conversion-PEGDMA fraction in feed (60° C., 0.1 g initiator and 1.2 g SDS tenside). FIG. 2 shows the results for a system with bulk of total monomers 1 and 2 g in the solution, monomer ratio NVP-PEGDMA changed in the feed. The higher the level of total monomers as 2.5 g in reaction mixture, the gelation occurs. The conversion of monomers at which there is an acceleration in conversion rate decreases with decreases in total monomers level. The conversion rate appears to increase with increase in divinyl monomer level. The conversion of monomers not exceeds 89%.

The percent conversion was calculated by the following equation:

$$Conversion ( C \% ) = \frac{weight of polymer formed}{weight of monomer charged} \times 100$$

See FIG. 2 which shows the Conversion-PEGDMA fraction curves for NVP-PEGDMA copolymers.

Water solubility

Solutions of copolymers were stable in room temperature clear or opalescent. The solubility of the particles dependent on the way of the preparation and the reaction condition. PEGDMA was used as a cross-linking agent, it is ratio was changed in the feed to reduce the size of the copolymer nanoparticle. Increasing the rate of the PEGDMA the framework of the produced nanoparticles became more compact with growing opalescenty. Increasing the rate of NVP in copolymers it is hydrophilic character became stronger to effect higher water solubility, and clearer solution.

TABLE 2
Transmittance of colloid solution.

| | Sample | Result | Transmittance, % |
|---|---|---|---|
| Bulk of total | VPP11 | Clear | 95 |
| monomers: 1 g | VPP10 | Clear | 94 |
| | VPP9 | Clear | 94 |
| | VPP8 | Clear | 94 |
| | VPP7 | Clear | 93 |
| | VPP6 | Clear | 92 |
| | P13 | Precipitate | — |
| Bulk of total | VPP5 | Clear | 92 |
| monomers: 2 g | VPP3 | Opalescent | 85 |
| | VPP1 | Opalescent | 80 |
| | P12 | Precipitate | — |

Co-tenside: 1.5 wt % (based on monomer) n-butanole. Initiator: potassium persulphate. Total solids: 3%. Temperature: 60° C. Reaction time: 120 min.

In micellar polymerization the colloid solution are clear or opalescent system, the transmittance is between 80% and 95%. Transmittance decreased increasing the amount of the cross-linking agent and increasing the concentrations of monomers transmittance decreased to 80%.

### Characterization of Nanoparticles

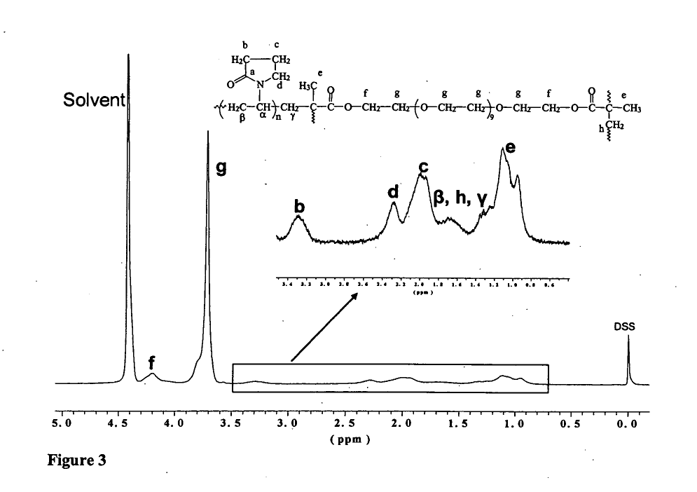

The structure of the NVP-PEGDMA nanoparticles was analyzed with NMR, ATR-FTIR. spectroscopy and elemental analysis. The ¹H NMR (FIG. 3) and ¹³C NMR assignments and chemical shifts of copolymer are: ¹H NMR (D₂O): δ=4, 3-4 ppm (f-CH₂), δ=4-3.6 ppm (g-CH₂), δ=3.7 ppm (\acute{α}-CH), δ=3.4-3.1 ppm (b-CH₂), δ=2.4-2.2 ppm (d-CH₂), δ=2.2-1.8 ppm (c-CH₂), δ=1.8-1.4 ppm (β, γ, h-CH₂), δ=1.4-0.6 ppm (e-CH₂). The areas under the f-CH₂ and b-CH₂ peaks are used to determine copolymer composition through the equation

$$\frac{[ NVP ]}{[ PEGDMA ]} = \frac{A ( b - CH 2 ) / 2}{A ( f - CH 2 ) / 4} \qquad ( 1 )$$

where A(b-CH₂) and A(f-CH₂) are the areas under the peaks. From equation the copolymer ratio is found to be various with the monomer ratio, because the reactivity of the NVP monomer reduced in continuous phase. See FIG. 3

There are some structural units that cannot be identified decidedly with ¹H-NMR (e.g. β, h, γ) or overlap too much in the ¹H-NMR spectrum (e.g. g, 6). FIG. 3 shows the ¹H-NMR spectrum of the purified copolymer with the monomer ratio M₁/M₂=8/2 after dissolved in D₂O. The chemical shift do not differ significantly from those detected for the copolymers at the same concentration, and only severely small differences in the line widths are observed as the PEGDMA ratio is increased from 0.2-0.9 in feed. Thus, the 1D spectrum supplies minor information about the mode of interaction between the two monomers.

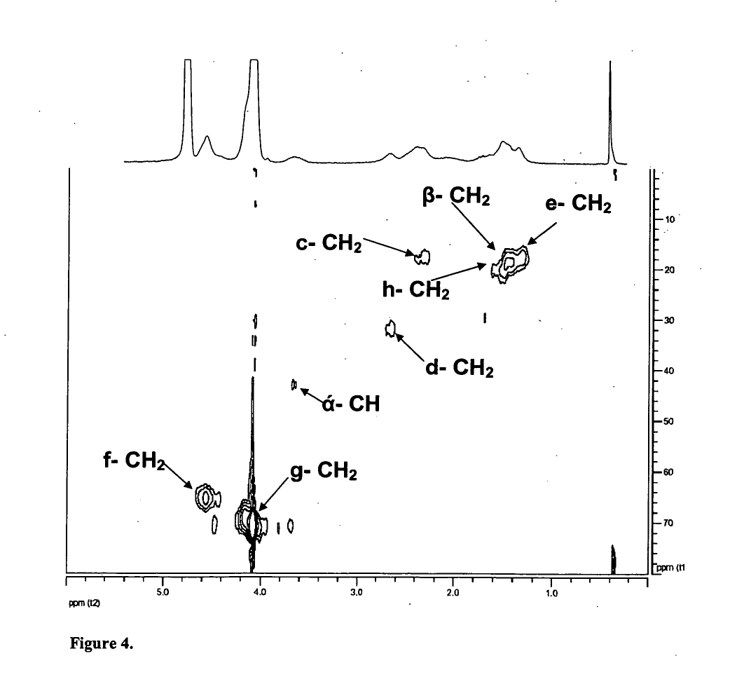

Assignment above was performed on the basis of ¹H-¹³C₂D HSQC NMR experiment. The assignment of the ¹H¹³C atoms are shown in FIG. 4.

FIG. 4 shows the 2D nuclear HSQC effect spectrum of the 50 mg/ml mixture. Here, the chemical shifts in ppm of the NVP-PEGDMA copolymer protons appear along the horizontal axis and the copolymercarbons (¹³C NMR (D₂O): δ=178 ppm (a-CO), δ=71 ppm (g-CH₂), δ=69 ppm (f-CH₂), δ=46-48 ppm (\acute{α}-CH), δ=43-46 ppm (b-CH₂), δ=33-37 ppm (β-CH₂), δ=32-33 ppm (d-CH₂), δ=19 ppm (c-CH₂)) along the vertical axis. We see much greater resolution of spectral fine structure than appears in the 1D spectra. Using the NMR spectra of the pure samples, it was possible to determine the composition of the copolymers.

ATR-FTIR spectra of all nanosystem showed the characteristic transmittance peaks of amide groups (N—H) around 1680 cm⁻¹. Elemental analysis shows the nitrogen content of the copolymers. See FIG. 5.

ATR-FTIR is an effective method for characterization of polymer surface chemistry. In this configuration, besides interesting data on the chemical structure of polymers, surface-sensitive information may be gained as well [Bodecchi]. FIG. 5 shows the ATR-FTIR spectrum of the purified copolymer with the monomer ratio M₁/M₂=8/2 made by micellar polymerization. The spectrum of NVP-PEGDMA is characterized-by the presence of the bonds at 1720 cm⁻¹, typical for vibrations of carbonyl groups. The broad and intense bond in the region 2700-3050 cm⁻¹ can be connected to stretching vibration of O—H bond. The broad and intense bonds centered at 1100 and 1500 cm⁻¹ are matched to C—O stretching vibrations. In polymers a 3° amide bond was observed at ˜1680 cm⁻¹ in the FTIR spectra, which is consistent with the literature.

TABLE 3
Elemental analysis of different cross-linked
NVP-PEGDMA copolymer.

| | NVP | | | NVP | NVP Fraction |
|---|---|---|---|---|---|
| | Fraction | N % | N % | Fraction | in Polymer by |
| Sample | in Feed | Calculated | Real value | in Polymer | NMR analysis* |
| VPP1 | 0.2 | 0.61 | 0.40 | 0.13 | |
| VPP2 | 0.3 | 1.00 | 0.52 | 0.16 | |
| VPP3 | 0.5 | 2.12 | 0.88 | 0.21 | |
| VPP4 | 0.7 | 4.04 | 1.28 | 0.22 | |
| VPP5 | 0.8 | 5.63 | 1.80 | 0.26 | |

Bulk of total monomer: 2.0 g. Co-tenside: 1.5 wt %.
*The NVP fraction in polymer calculated by the (1) equation.

FIG. 5 is the IR spectrum of the NVP-PEGDMA copolymer. The transmittance bond at 1680 cm⁻¹ indicates the introduction of the amide group into the copolymers. Table 3. shows the mole fraction of monomer units in copolymer nanospheres determined from the nitrogen content by elemental analysis. The values for the samples are somewhat lower than the predicted value from monomer reactivity ratio. Experimental results are reported on monoyinyl-divinyl copolymerization in which the fraction of cross-linking agent is large to 90 percentage in the micelles. Micellar polymerization method was the increased reactivity of the PEGDMA macromere when solubilized in the micelles. Experiments were small reactivity of the vinyl groups from the NVP. The NVP can then react or remain pendant. NVP content of the polymer NPs increases with conversion. NMR and IR spectra and the results of elemental analysis confirm the chemical structure of the obtained NVP-PEGDMA copolymer.

### Particle Size and Morphology

Particle size of NVP-PEGDMA nanoparticles was determined by TEM, DLS and SEM. The TEM and SEM supplied the most through information on size, particle size distribution (PSD) and shape of the NVP-PEGDMA NPs. The DLS technique is one of the most popular methods used to determine the size of particles and polydispersity index.

### Transmission Electron Microscopy

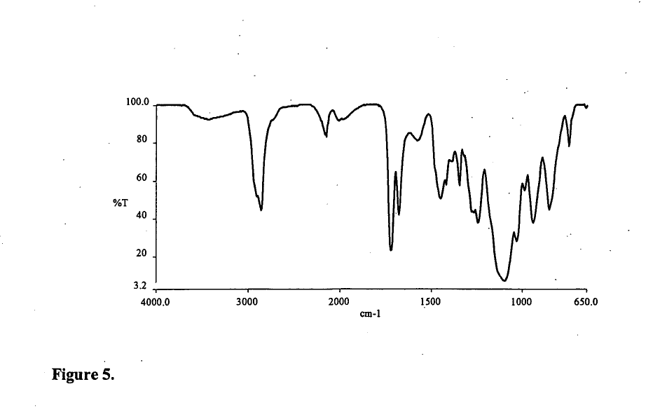

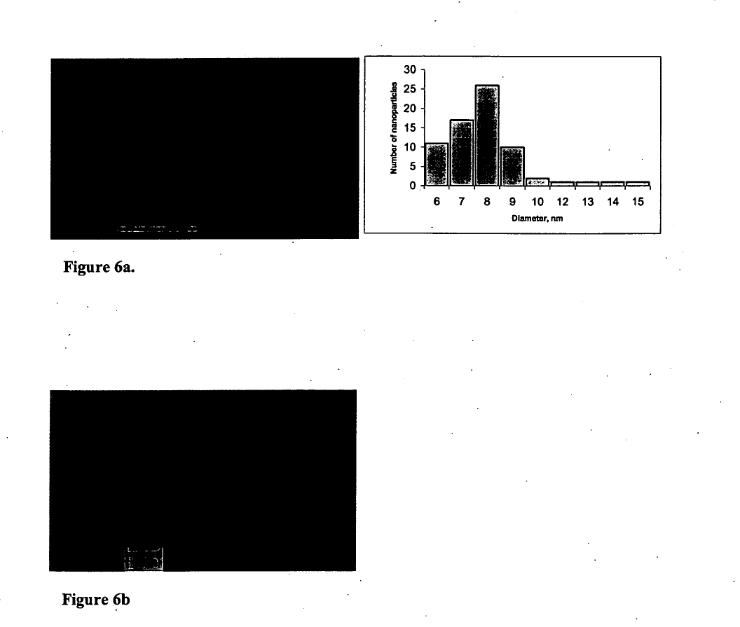

TEM micrographs of cross-linked nanoparticles of copolymer were taken from the reaction mixture after dialysis (FIG. 6a) or from the reaction mixture after freeze dried (FIG. 6b), with concentration of 500 μg/ml. It was shown that nano-system can be prepared as a colloid solution, wherein the cross-linked copolymer NPs separated into spherical particles in an aqueous environment and in dried states. TEM micrographs (FIG. 6a) confirmed the nano-size of dried single 20% cross-linked copolymer particles, and show the distribution of these particles. The size distribution destined from 70 particles, the mean diameter (number average) is 8 nm. Size of dried single particles was between 7-1.0 nm on the basis of TEM micrographs, depending on the cross-linking PEGDMA ratios. Similar narrow size ranges can be observed in case of every samples with different cross-linking ratio. A typical micrograph is shown in FIG. 6b. As shown in the FIG. 6b, the mean diameter is about 100 nm, whereabout the nanoparticles are aggregated together. It can be look that at after dialysis a mono dispersed NPs size of between 7-10 nm content. Nevertheless at after freeze-dried a multimodal PSD of NVP-PEGDMA NPs can be look, because the single particles aggregated to each other. The diameters of cross-linked NVP-PEGDMA NPs resulting from the TEM experiments were smaller than in swollen state measured by DLS.

Scanning electron microscopy

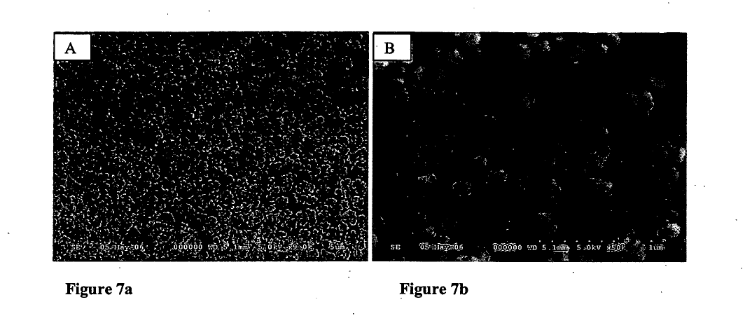

FIGS. 7a and b shows the SEM photograph of NVP-PEGDMA NPs. The shape of NPs is mostly spherical with wide size distribution aggregate NPs, some particles are nonspherical, ellipsoidal, as the amount of NVP is increased. The nanoparticles are aggregated together and their sizes and shapes are involved to identify, the size of same isolated aggregated particle look to be principally during about 100 nm sized spherical. A lot ofparticles show the slight aggregation among particles after freeze-drying. This is probably due to the solubility of NVP in water. Particle size of swelled latex equals the size of dried NPs measured by SEM. The size of nanospheres a little bit decreased with the increasing fraction of PEGDMA. Smallest particles were observed for monovinyl/divinyl=1/9 monomer ratio. The copolymerization of PEGDMA yields low size mono/polydisperse nanospheres with growing conversion. The change in size depends on the mole fraction of monomers. In comparison with the TEM and DLS values, it was observed that these particles on the SEM specimen grids were rather flat spheres, due to low crosslinking- density the third dimension was reduced and the particles appeared to have a larger diameter.

FIG. 7 shows the SEM image of preparated NVP-PEGDMA copolymer nanospheres. There are no substantial differences in the morphology of different total monomer concentration copolymer nanospheres shape and size (100 nm). The NVP-PEGDMA 8/2 nanospheres are shown in FIG. 7a. The mean diameters decreased with the increase of PEGDMA in the polymer: 50-100 nm (M₁/M₂=1/9), 75-130 nm (M₁/M₂=5/5) and 100-150 nm (M₁/M₂=8/2).

This picture was made from a sample when it was swelled in deionized water solution.

### DLS

DLS was used for NPs sizing, Different methods (TEM, SEM, DLS) were used to determine the size and particle size distribution (PSD) of the particle populations. Solution samples were prepared from the reaction mixture after dialysis. The concentration of the copolymer solution was around 100 μg/ml, at a scattering angle of 90° for aqueous solutions of NVP-PEGDMA NPs. In this work the solution consist of single particles and more or less aggregates depending on the cross-linking PEGDMA conditions under which the particles have been prepared.

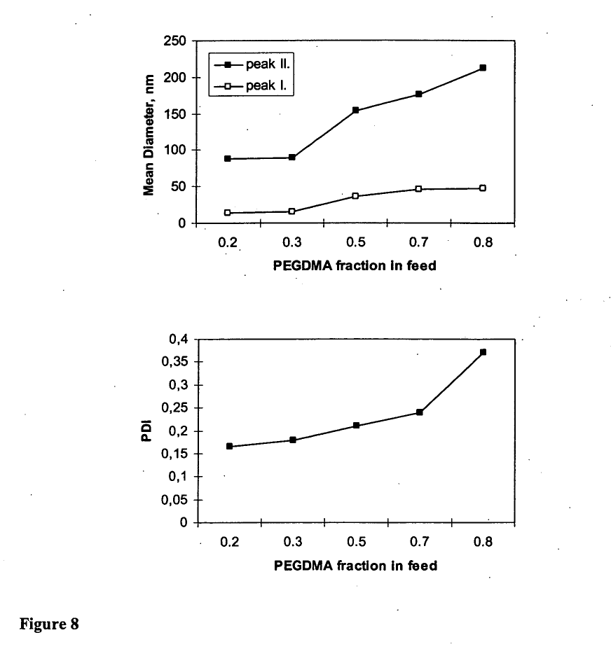

FIG. 8. shows the particle size of polymer using different monomer ratios obtained by micellar polymerization DLS measurements The NPs prepared with the percentage of PEGDMA 20% is stable and the HD measured by DLS was at a maximum of 88.6 nm. However, increasing the monomer ratio of M₂ in the feed resulted in larger particles, because the swelling ratio depends on the density of cross-linking. The particle size of the unswelled polymer increases steadily with increasing the ratio of M₂ monomer in the feed. As is shown in FIG. 8. the size of particles increase gradually to 213 nm. In these systems the dependence on concentration is ignored. The same trend is perceptible for the polydispersity. (index if the dimensional homogeneity of particles) so when the percentage of PEGDMA in copolymer increases the particles have a lower dimensional homogeneity. The polydispersity index was 0.166 for with PEGDMA ratio was 20%, to increase to 0.370 for with PEGDMA ratio in feed was 90%. The polydispersity can be calculated by

M_{w}/Mₙ=(p+5)(p+4)(p+3)/[(p+2)(p+1)p]

where M_{w}/Mₙ weight-to-number average molar mass ratio.

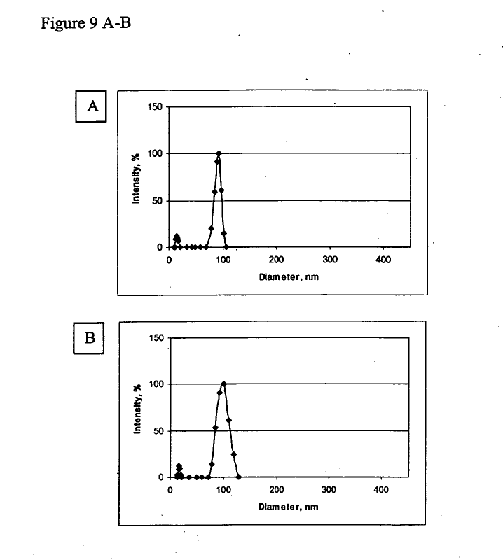

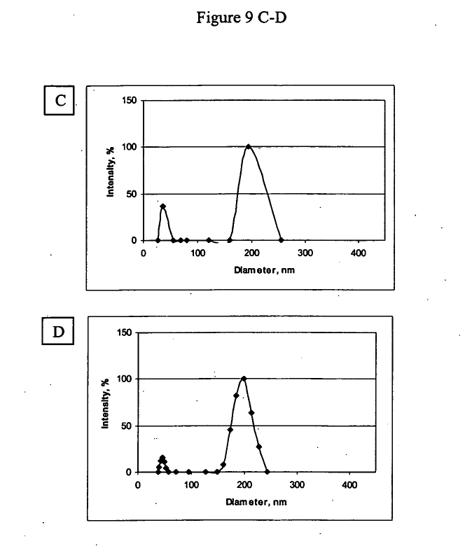

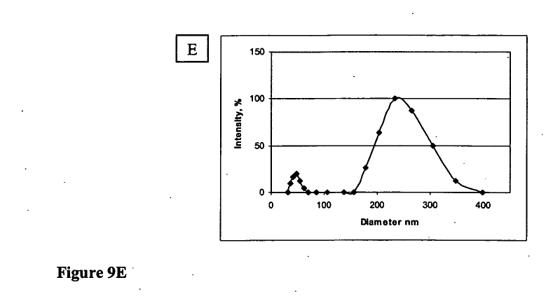

FIG. 9 shows the particle size distribution (PSD) calculated by NNLS. The results submit that the system can be presented by a bimodal distribution of particles sizes, peak (I) represents average size of single particles and peak (II) reflects the average size of small aggregates and larger clusters of particles (large NPs coils). The average values increase, and the distribution curve shifts toward the high molecular size region: the ratio of the large particles increases. The intensity of the large particles gives an increasing part of the sum intensity. (Szuromi). With this technique the hydrodynamic diameter is measured, too. The largest polymer particles with highest cross-linking-density display lower swelled size.

Water soluble, cross-linked nanoparticles were prepared by copolymerization of NVP with PEGDMA. PEGDMA was cross-linking agent. Reactions were conduced with free-radical polymerization initiating with potassium persulphate. Oil in water emulsion and micellar polymerization was formed to obtain nanosystems. It is soluble in water due to NVP monomers. Concentration of NVP in the copolymer is much lower than that of in the monomer feed. The size of nanoparticles depends on the reaction conditions; their value varied in the range of 10-233 nm.

### EXAMPLE 2

Reagents. Monomers: acrylic acid and bis[2-(methacryloyloxy)-ethyl]-phosphate was purchased from Sigma-Aldrich Kft, Budapest, Hungary and it was used as received. Sodium dodecyl sulphate.(SDS) (99% purity) was used without further purification. The initiator potassium persulphate (98% purity) was recrystallized from deionized water.

Instrumentation. Copolymer composition was determined by ¹H and ¹³C NMR spectroscopy on a Bruker SY200 instrument at 200 MHz frequency and at ambient temperature. Polymer sample was dissolved in deuterium oxide (D₂O) containing DSS as a reference. Dynamic light scattering measurements were carried out at 25° C. by Brokhaven laser light scattering instrument equipped with a 10 mW Nd:YAG laser (wavelength: 532 μm). The IR spectroscopy measurements were performed on Perkin Elmer Spectrum One instrument and spectra were obtained in reflexion mode. Particle size was characterized by JEOL 2000 FX-II transmission electron microscope (TEM).

### Results

The batch copolymerization of acrylic acid with bis[2-(methacryloyloxy)ethyl]phosphate was performed in 150 ml three-necked, round-bottomed flask equipped with a condenser, and nitrogen inlet/outlet and magnetic stirrer. Copolymers were synthesized using free radical copolymerization. Potassium persulphate was the initiator in 50 ml reaction mixtures. The oxygen was removed by purged nitrogen for 20 minutes on ambient temperature before the reaction was started. Every reaction was conduced with continuous stirring with magnetic stirrer under nitrogen atmosphere during the whole reaction time. The reaction was started by thermostating the mixture to 60° C. with thermostated water bath. After cooling the final reaction mixture, the aqueous polymer solutions were purified by dialysis for a week and with freeze drying. Conversions were obtained gravimetrically. The overall concentration of monomers was 4 wt. %, and the concentration of the initiator K₂S₂O₈ was 0.09 wt. %. The concentration of SDS used was 0.4 wt. %. Reactions were driven for 2 hours. Two different reaction techniques were used: homogenous and micellar.

In both of these processes, the reaction temperature and stirring rate must be adequately controlled, the nucleation stage must be short/same, the particle growth must be approximately constant.

A. Homogeneous Method

In the homogenous solution a dioxane-water mixture was used as a solvent because BMOEP is hardly soluble in water and fairly soluble in organic solvents. The dioxane-water mixture was chosen as the solvent because dioxane can be easily mixed with water and it is also a good solvent for BMOEP. A 1:3 ratio and a 2:3 ratio were used for these two solvents wherein AA, BMOEP and the initiator were dissolved. Reactions were conduced as described above.

B. Micellar Method

In the second method an ionic surfactant, sodium dodecyl sulphate (SDS) was used to make soluble BMOEP. AA and BMOEP were added to an SDS solution, and dispersed in an ultrasonic bath for 15 minutes. Then potassium persulphate solution was added and reactions were started as described above. At the end of the reaction a viscous, homogeneous and clear polymer solution was obtained.

Determination of particle size. Size of particles was determined in solution by laser light scattering (DLS), Gel Permeation Chromatography (GPC) and Transmission Electron Microscopy (TEM). DLS and GPC samples were dissolved in phosphate buffer solution containing 0.15 M Na₂HPO₄ and 0.1 M NaH₂PO₄ in order to maintain the pH at 6.8.

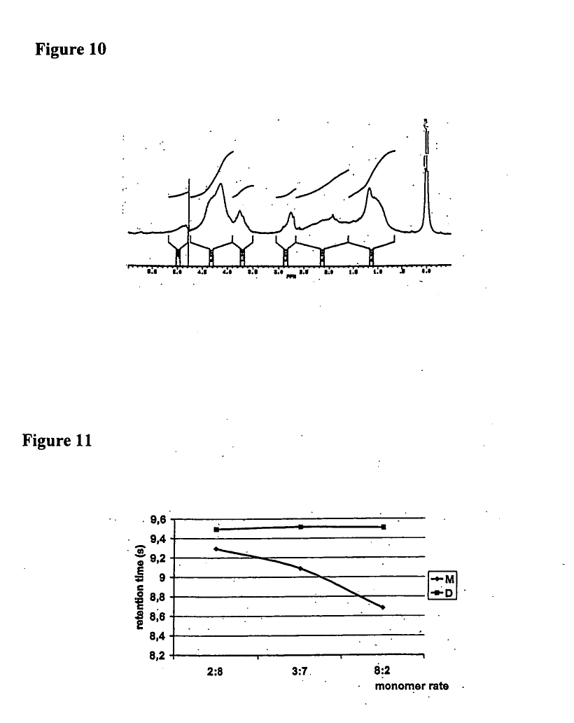

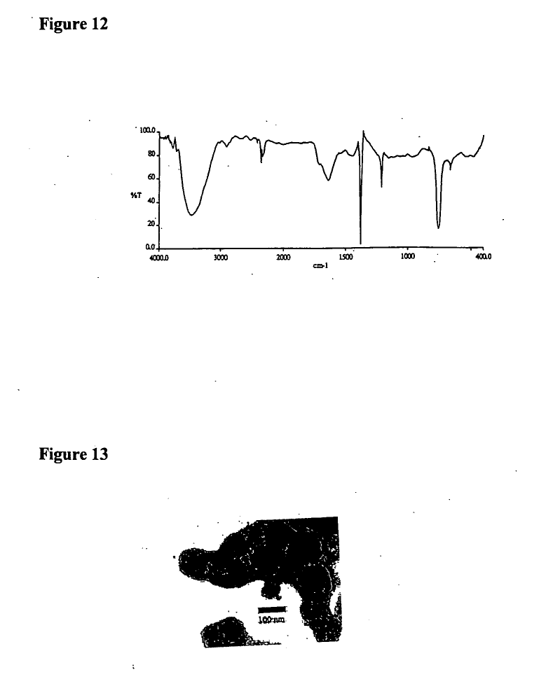

FIG. 10 is a ¹H NMR spectrum of AA-BMOEP (2:8). d=0.5-1.5 ppm (CH₂), d=1.6-2.6 ppm (CH), d=2.8 ppm (CH—O—CO), d=3.7 ppm (3-CH—O—PO₃), d=3.9-4.7 ppm (CH—COOH). FIG. 11 shows GPC peaks of AA-BMOEP (A:B) crosslinked hydrophilic copolymer nanoparticles with monomer feed of A:B=2:8, 5:5 and 8:2 (M) obtained by micellar polymerization process, (D) obtained by homogeneous mixed solvent (water-dioxane) medium. FIG. 12 is an IR spectrum of AA-BMOEP (2:8). The IR analysis proves the formation of amide bond between the amine group of crosslinker and the carboxylic group of PAA. Significant bands are: n=3470 n=2353 n=1642 (CO).

FIG. 13 is a TEM micrograph of a water soluble copolymer (bar=100 nm).

TABLE 4
Dependence of the diameter on monomer ratio.

| Monomer ratio | Eff. diam. (nm) | Peak I. (nm) | Peak II. (nm) |
|---|---|---|---|
| 2:8 | 450 ± 10 | 150 ± 40 | 1000 ± 500 |
| 3:7 | 245 ± 10 | 190 ± 60 | 1500 ± 600 |
| 5:5 | 335 ± 10 | 180 ± 90 | 1500 ± 50 |
| 7:3 | 265 ± 10 | 200 ± 50 | 900 ± 100 |
| 8:2 | 440 ± 10 | 310 ± 50 | 700 ± 100 |

Effective diameter (Eff. Diam.) comes from the second commulant analysis, and the peaks from the NNLS analysis.

GPC measurements provide apparent molecular weight of polymeric nanoparticles and polydispersity.

### EXAMPLE 3

### Experimental

Materials: N-vinyl-2 pyrrolidinon 99+%, was purchased from Sigma-Aldrich Co., Budapest, Hungary (NVP). As a crosslinker poly(ethylene glycol) dimethacrylate was applied, was obtained from Sigma Aldrich Co., Hungary (PEGDMA). As a solvent toluene (Spektum 3D Co., Hungary) and deionised water were used. The initiator was potassium persulphate (Reanal Co., Budapest, Hungary). As a emulsifier sodium-lauryl sulphate was applied, was can be obtained from Chemolab Co., Budapest, Hungary. Kostabilizatorkent n-BuOH.

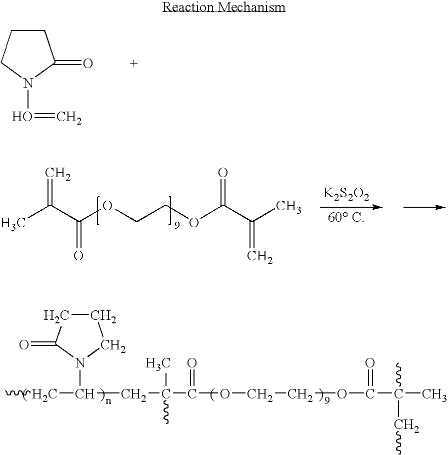

Instrumentation. Structure of prepared colloid system was analyzed by NMR spectroscopy using Bruker DRX 500 and SY 200 instrument. Samples were dissolved in D₂O and DSS was the inner standard. IR spectroscopy measurements in reflexion mode. Particles sizes of NVP-co-PEGDMA copolymer derivatives were characterized by JEOL2000 FX-II transmission electron microscope (TEM) and dynamic laser light scattering (DLS) was used to determine the size of swollen particles in aqueous medium. Brookhaven BI 900 light scattering instruments equipped with 10 mW Nd-YAG laser (532 nm) as an incident beam at 25° C.

### Results and Discussion

### Synthesis of Macromolecules

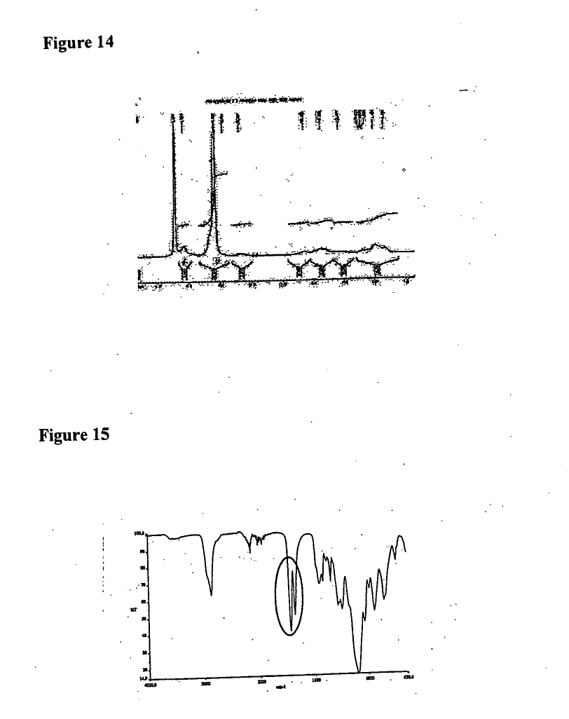

Structure. NVP-co-PEGDMA was characterized by NMR spectroscopy. ¹H NMR signals of a copolymer is given in FIG. 14. Proton signals of PEGDMA content are broad reflecting crosslinked structure. FIG. 15 shows the IR spectra of 20% crosslinked copolymer. The IR analysis proves the formation of amide bond.

Significant bands are: v=1682 cm⁻¹ (amidel linkage), v=1722 cm⁻¹ (carbonyl group of ester linkage).

Particle size. Particle size of NVP-co-PEGDMA was determined by TEM and DLS.

TEM micrographs of crosslinked copolymer nanoparticles were carried out reaction compound after dialysis, with concentration 100 μg/ml. Size of dried particles was between 50-150 nm on the basis of TEM micrographs, depending on the crosslinking ratios.

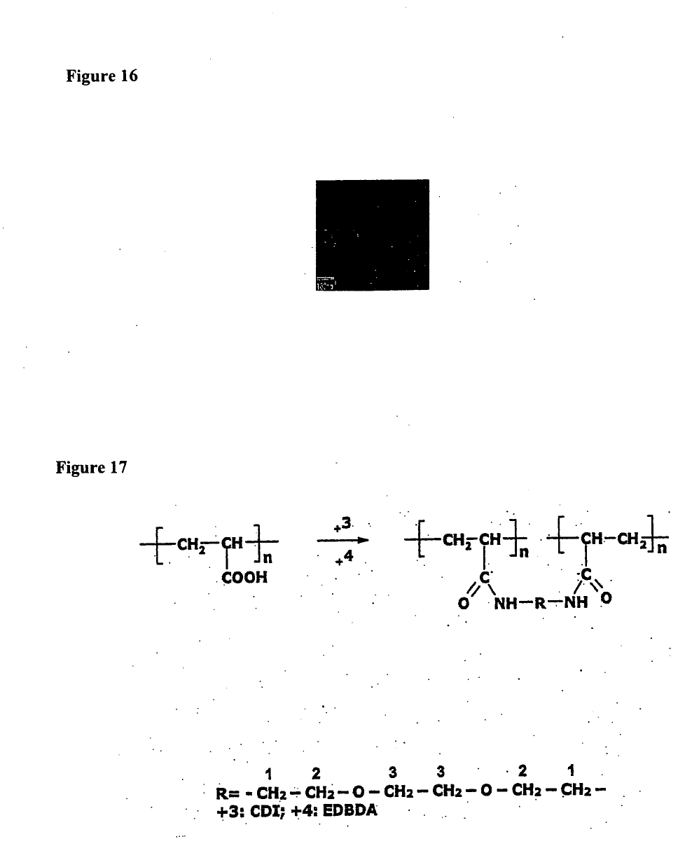

FIG. 16 shows a TEM micrograph of NVP-PEGDMA copolymer 50% crosslinked (bar: 100 nm)

Hydrodynamic diameter of these materials was measured in solution at a concentration of 100 μg/ml, at scattering angle 90° Hydrodynamic diameter values of NVP-co-PEGDMA 30% crosslinked are shown in Table 5.

TABLE 5
Hydrodynamic diameter values measured by DLS

| | Total monomer/50 ml (g) | | | | |
|---|---|---|---|---|---|
| | 1.54 | 1.76 | 1.98 | 2.2 | 2.42 |
| Size of | 218 ± 20 | 138 ± 15 | 111 ± 15 | 101 ± 20 | 80 ± 15 |
| particles | nm | nm | nm | nm | nm |
| (DLS) | | | | | |

### EXAMPLE 4

Reagents. Linear polyacrylic acids (PAA) with different molecular weight (Mw=1×10⁵; 4.5×10⁵; 7.5×10⁵), were obtained from Sigma-Aldrich Kft, Budapest, Hungary. As a crosslinker-2,2′-(ethylenedioxy) bis(ethylamine) (EDBDA) was applied. Water soluble 1-(3-(dimethylamino)propyl)-3-ethylcarbodiimide hydrochloride (CDI) was the condensation agent.

Instrumentation. Structure of prepared nanocolloid system was analyzed by ¹H and ¹³C NMR spectroscopy using Bruker DRX 500 and SY 200 instruments. Samples were dissolved in D₂O and DSS was the inner standard. IR spectroscopy measurements were performed on Perkin Elmer Spectrum One Instrument and spectra were obtained in reflexion mode. Particle size was characterized by JEOL 2000 FX-11 transmission electron microscope (TEM) was used to measure the particle size of dried NPs. Dynamic laser light scattering (DLS) was used to determine the size of swelled particles in aqueous medium run on Brookhaven B1900 light scattering instrument equipped with 10 mW Nd-YAG laser (532 nm) as an incident beam at 25° C.

### Results and Discussion

Crosslinking reactions may result in inter and intramolecular couplinds. In present example, the concentration of the starting PAA aqueous solution was adjusted to avoid the intermolecular reactions. When the concentration was 20 mg/ml, gel formation was observed. In the range of 10-20 mg/ml, no gelation occurred, however the DLS measurements showed formation of polydisperse particles. Experiments with concentration of 1-5 mg/ml PAA solution demonstrated generation of PAANPs with low polydispersity as 1.1.

The structure of NPs was determined by NMR and IR spectroscopy. The size of particles was determined in aqueous solution by DLS measurements. The TEM micrographs demonstrated particles with diameters of 85-95 nm.

FIG. 17 is the crosslinking reaction of PAA.

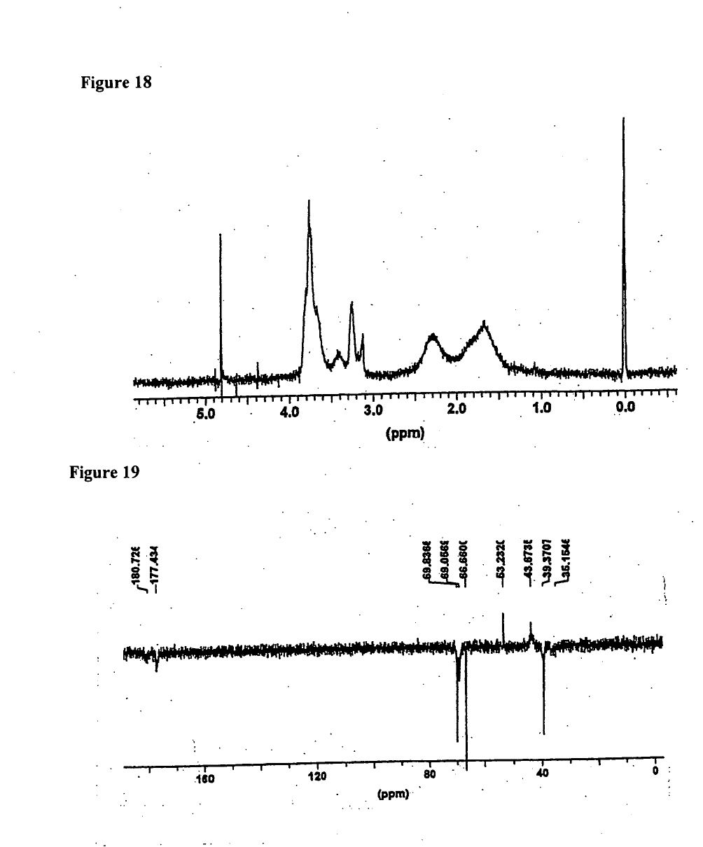

FIG. 18 is the ¹H NMR of 50% crosslinked PAANP (M_{w} of starting PAA was 100 kDa): delta=1.5-2.0 ppm (CH₂-AA monomer unit), delta=2.1-2.5 ppm (CH-AA monomer unit), delta=3.2 ppm (1-CH₂), delta=3.7 pm (3-CH₂), delta=3.8 ppm (2-CH₂).

FIG. 19 is ¹³C NMR of 75% crosslinked PAANP (PAA M_{w}=450 kDa): delta-36.7 ppm (CH₂-AA monomer unit), delta-43.5 ppm (CH-AA monomer unit), delta-39.3 ppm (1-CH₂), delta=66.6 ppm (2-CH₂), delta=69.8 ppm (3-CH₂), delta=177.4 ppm (CONH), delta=181.3 ppm (COOH).

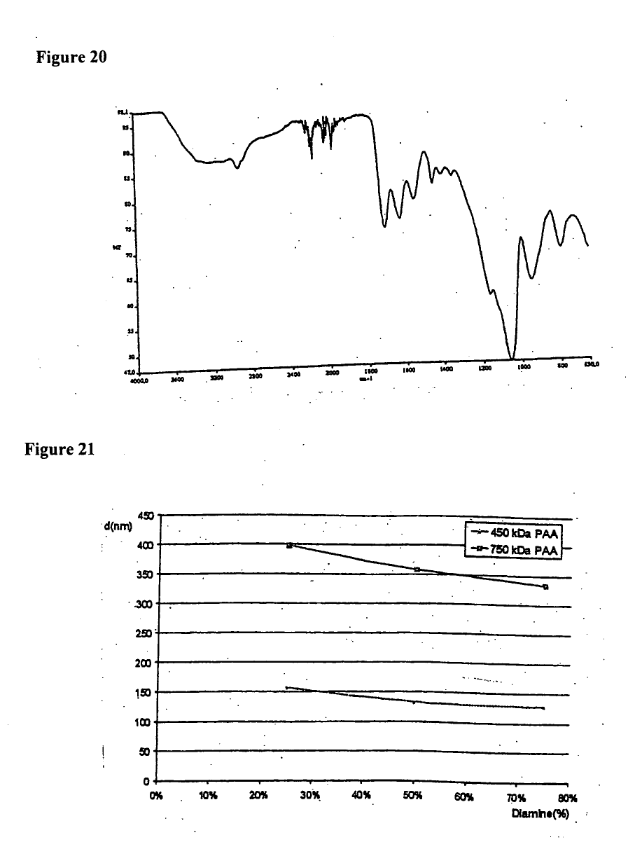

FIG. 20 is IR spectra of 15% crosslinked PAANP (PAA M_{w}+100 kDa). The IR analysis proves the formation of amide bonds between the amine group of crosslinker and the carboxylic group of PAA. Significant bands are: v=1709 (COOH), v=1628 (CO), v=1552 (Amide 1).

FIG. 21 is dependence of the diameter on crosslinking ratio. Mw of starting PAA was 450 and 750 kDa, and the crosslinking ratio was 25%, 50% and 75%, respectively.

Determination of Particle Size. Size of particles was determined in solution by laser light scattering (DLS). Nanoparticles were dissolved in phosphate buffer solution containing 0.15 M Na₂HPO₄ and 0.1 M NaH₂PO₄ in order to maintain the pH at 6.8. FIG. 21 shows that the diameters decrease when the ratio of crosslinking increases.

TABLE 6

| | |
|---|---|
| | Diameter |
| Crosslinking ratio | (nm) |

| (%) | 450 kDa | 750 kDa |
|---|---|---|
| 25 | 157 | 398 |
| 50 | 132 | 359 |
| 75 | 128 | 334 |

Table 6 shows the dependence of the diameter on crosslinking ratio and the M_{w} of the starting PAA.

We claim:

1. A method of forming cross linked hydrophilic nanoparticles comprising copolymerizing an acrylic acid with a bis[z-methacryloyloxy)-ethyl]-phosphate.

2. The method according to claim 1 wherein the polymerization reaction is a free radical polymerization initiated with potassium persulphate.

3. The method according to claim 2 wherein the polymerization reaction occurs in a homogeneous solution with a dioxane water mixture as a solvent.

4. The method according to claim 2 wherein the polymerization reaction occurs in a sodium dodecyl sulphate solution.

5. The method according to claim 1 wherein the acrylic acid, bis, etc., and an initiator are dissolved in a mixture of dioxane and water.

6. The method according to claim 5 wherein the ratio of dioxane to water is from about 1:3 to about 2:3.

7. The method according to claim 1 wherein the acrylic acid and bis[z-methacryloyloxy)-ethyl]-phosphate are added to an ionic surfactant.

8. The method according to claim 7 wherein the ionic surfactant is a sodium dodecyl sulphate.

9. The method according to claim 8 wherein an initiator is added to the solution.

10. The method according to claim 9 wherein the indicator is potassium persulphate.

11. A crosslinked hydrophilic nanoparticle comprising the reaction product of a polymerization reaction of an acrylic acid and a bis[z-methacryloyloxy)-ethyl]-phosphate.

12. The nanoparticle according to claim 11 wherein the polymerization reaction is a free radical polymerization reaction initiated by a potassium persulphate.

13. The nanoparticle according to claim 12 wherein the reaction occurs in a homogeneous solution with a dioxane water mixture as a solvent.

14. The nanoparticle according to claim 12 wherein the polymerization reaction occurs in a dodecyl sulphate solution.

15. A method of preparing crosslinked hydrophilic nanoparticles comprising reacting N-vinyl-2 pyrrolidinon with a poly (ethylene glycol) dimethacrylate in an organic solvent.

16. The method according to claim 15 wherein the reaction is initiated by potassium persulphate.

17. The method according to claim 16 wherein the reaction occurs in the presence of an emulsifier.

18. The method according to claim 17 wherein said emulsifier is sodium laurel sulphate.

19. A cross linked hydrophilic nanoparticle comprising the reaction product of the following reactants: a N-vinyl-2 pyrrolinon, a poly (ethylene glycol) dimethacrylate, an organic solvent and an initiator.

20. The nanoparticle according to claim 19 wherein th initiator is potassium persulphate.

21. The nanoparticle according to claim 20 wherein the reactants further comprise and emulsifier.

22. The nanoparticle according to claim 21 wherein said emulsifier is sodium laurel sulphate.

23. A method of preparing polyacrylic acid nanoparticles comprising crosslinking a polyacrylic acid in an amidation reaction with a diamino compound.

24. The method according to claim 23 wherein the diamine compound is 2,2-(ethylenedioxy)bis(ethylamine).

25. The method according to claim 24 wherein the amidation reaction produced is condensed with 1-(3-dimethylamino)propyl)-3-ethylcarbodiimide hydrochloride.

26. The method according to claim 25 where the polyacrylic acids are linear.

27. The method according to claim 26 wherein the concentration of the starting concentration of polyacrylic acid aqueous solution was about 10 to about 20 mg/ml.

28. A polyacrylic acid based nanoparticle comprising the reaction product of a polyacrylic acid crosslinked by an imitation reaction with a diamine compound.

29. The nanoparticle according to claim 28 wherein the diamine compound is 2,2- (ethylenedioxy)bis(ethylamine).

30. The nanoparticle according to claim 29 wherein the imitation reaction product is condensed with 1-(3-dimethylamino)propyl)-3-ethylcarbodiimide hydrochloride.
